(19) United States
(12) Patent Application Publication
(10) Pub. No.: US 2019/0051908 A1
(43) Pub. Date: Feb. 14, 2019

(54) HORIZONTAL TRI-ELECTRODE SINGLE FLOW ZINC-AIR BATTERY WITH A FLOATING CATHODE

(71) Applicants: Zhongwei CHEN, Waterloo (CA); Hao LIU, Waterloo (CA)

(72) Inventors: Zhongwei CHEN, Waterloo (CA); Hao LIU, Waterloo (CA)

(73) Assignees: Zhongwei Chen, Waterloo, ON (CA); Hao LIU, Waterloo, ON (CA)

(21) Appl. No.: 15/762,417

(22) PCT Filed: Sep. 23, 2016
(86) PCT No.: PCT/CA2016/051125

§ 371 Date: Mar. 22, 2018

Related U.S. Application Data
(60) Provisional application No. 62/284,196, filed on Sep. 23, 2015.

(51) Int. Cl. H01M 4/86; H01M 12/08; H01M 2/02

(52) U.S. Cl. CPC H01M 4/8621; H01M 12/08; H01M 2004/8689; H01M 4/8626; H01M 2/0255

(57) ABSTRACT

A rechargeable horizontally configured tri-electrode single flow zinc-air battery with a floating cathode, which is theoretically capable of providing unlimited cycle life is provided. The tri-electrode configuration consists of one anode and two cathodes, one for charging and one for discharging. The charge cathode may comprise a water permeable alkaline resisting metal/mesh foam, which avoids carbon corrosion. The floating discharge cathode comprises an air permeable and water permeable catalytic oxygen reduction electrode, which eliminates or reduces the blockage of air tunnels. The anode comprises an inert, conductive electrode allowing for zinc deposition during battery charging and zinc dissolving during battery discharging. The flowing electrolyte removes zinc ions from the anode preventing or minimizing the formation of zinc oxides during discharging and cleans the anode after each full discharge. The horizontal configuration further eliminates or reduces electrolyte leakage.

### CROSS REFERENCE TO PRIOR APPLICATIONS

The present application claims priority under the Paris Convention to U.S. Application No. 62/284,196, filed Sep. 23, 2015, the entire contents of which are incorporated herein by reference.

### FIELD OF THE DESCRIPTION

The present description relates to the field of electrochemical energy conversion and storage devices and its applications. In particular, the invention relates to an improved horizontally configured rechargeable tri-electrode zinc-air (or zinc-oxygen) battery that includes a floating discharge cathode and a flowing electrolyte.

### BACKGROUND

Rechargeable zinc-air batteries are a highly promising technology due to a number of important advantages. For example, zinc-air batteries use oxygen from atmospheric air, which has no cost and is virtually inexhaustible, eliminating the need to store a fuel source within the battery. Furthermore, catalysts used in zinc-air batteries electrochemically reduce oxygen but are not used in the actual current generating reaction, which makes it theoretically possible for them to function for an unlimited period of time. In addition, the active materials in zinc-air batteries are oxygen and zinc, which makes them affordable, safe, and environmentally friendly. However, there remain several technical issues which hamper the commercialization of rechargeable zinc-air batteries.

The first issue is the corrosion of carbon contained in the cathode, which occurs during the charging phase of the battery. In conventional rechargeable zinc-air batteries, the charge and discharge cycles use the same cathode, which comprises a porous carbon material on which are supported the required catalysts. This cathode plays an important role in the oxygen evolution reaction (OER) and the oxygen reduction reaction (ORR) of the battery. However, during the process of OER a side reaction occurs wherein the carbon is corroded. In particular, the carbon is oxidized into CO₂. Once the carbon carriers oxidize and disappear, the catalysts supported on carbon lose contact with the electrode, which makes them ineffective, resulting in fading of the battery's performance.

The second issue associated with conventional zinc-air batteries is the shape change and formation of zinc dendrites that occurs at the anode. In conventional rechargeable zinc-air batteries, during the discharging phase, zinc particles on the anode are oxidized into zinc ions that move into the electrolyte. However, these ions have poor solubility in the alkaline electrolyte so they are almost immediately deposited on the anode as zinc oxide particles. During the charging phase, zinc oxide particles transform into zinc particles. These zinc particles may shift downward because of gravity during long period cycling, which may cause a change in the shape of the anode. The zinc particles may also form zinc dendrites on the anode. The change in shape of the anode may lead to energy fading and the formation of zinc dendrites may cause sudden death of the battery.

The third issue is the blocking of air tunnels in the cathode. In conventional rechargeable zinc-air batteries the cathode is comprised of a carbon based hydrophobic catalytic layer and a super hydrophobic gas diffusion layer. The cathode is inherently porous, which causes electrolyte to gradually leak out over time, this occurrence combined with capillary action gives rise to water sphere formation on the back of the electrode. The water spheres evaporate faster than the electrolyte is able to move out of the pores resulting in the formation of solid KOH which reacts with atmospheric CO₂ to precipitate K₂CO₃ solids. These solids gradually move inside the porous cathode and eventually block the air tunnels, which can cause a drop in performance of the battery.

The fourth issue is the increased risk of electrolyte leakage in large scale cells. The housing of zinc-air batteries must endure pressure from the electrolyte it contains caused by gravity. Conventional rechargeable zinc-air batteries are vertically configured and many screws are required along the perimeter of the housing to contain the electrolyte and prevent leakage. Increasing the size of the battery cell increases the pressure on these screws, which increases the risk of electrolyte leakage. Electrolyte leakage can cause the battery to deteriorate or malfunction.

U.S. Pat. No. 3,532,548 teaches a tri-electrode zinc-air battery and although providing improvements, does not solve the issue of shape change and zinc dendrite formation.

CN 101783429 teaches an alkaline single flow zinc-oxygen battery, where a flowing electrolyte was used to remove zinc ions from the anode so as to avoid partial saturation of zinc ions and the formation of zinc oxides during the battery discharge phase. The battery taught in this reference uses a bi-functional cathode but still comprises a two electrode cell. The reference does not address the issue of carbon corrosion. The battery taught in this reference is therefore not suitable for long term use.

CN 105098292 teaches a horizontally configured tri-electrode zinc-air battery, wherein each electrode is fixed or mounted to the housing and the discharge cathode is positioned such that one side of the electrode is exposed to air and a second side is exposed to electrolyte. Despite providing improvements, the electrolyte volume in the housing may change during cycling due to inefficient charging, which could cause both sides of the discharge cathode to be fully exposed to electrolyte at any given time. These changes may cause the battery to stop functioning.

There exists a need for a zinc-air (or zinc-oxygen) battery that addresses at least some of the issues described above.

### SUMMARY OF THE DESCRIPTION

The present description provides a horizontally configured tri-electrode rechargeable zinc-air battery with a floating cathode, which aims to solve at least one of the aforementioned issues that occur with conventional zinc-air batteries.

The description provides a battery having a horizontal tri-electrode configuration with one anode and two kinds of cathodes. One cathode serves the purpose of charging and the other serves the purpose of discharging. The charge cathode for oxygen evolution preferably comprises an electrolyte permeable metal mesh/foam electrode. The discharge cathode for oxygen reduction preferably floats on the surface of the electrolyte with a first side exposed to air or oxygen and a second opposite side exposed to electrolyte. The discharge cathode preferably comprises a conductive air-permeable and water permeable catalytic electrode.

The anode described herein comprises an inert conductive electrode, wherein zinc is deposited on the surface during the battery charging phase and zinc is dissolved from its surface during the battery discharging phase.

The battery described herein includes a flowing electrolyte, which removes zinc ions away from the anode to avoid partial saturation of zinc ions and the formation of zinc oxides during the battery discharge phase. In this manner, the surface of the anode is “cleaned” by the flowing electrolyte and is maintained at or close to its “fresh” state after every full discharge. The associated drawbacks with anode shape change and the formation of zinc dendrites are therefore avoided.

Thus, in one aspect, there is provided a horizontally configured zinc-oxygen battery, comprising:

a housing containing at least one discharge cathode, at least one charge cathode, and at least one anode, wherein each of the at least one discharge cathode, the at least one charge cathode, and the at least one anode are horizontally configured;

an electrolyte adapted to flow through the housing, the electrolyte comprising a solution containing at least one zinc salt dissolved therein;

the at least one charge cathode comprising a non-carbon metal mesh and/or metal foam material;

the at least one anode and the at least one charge cathode being provided within the housing and submerged in the electrolyte; and

the at least one discharge cathode being provided in the housing and is adapted to float on the surface of the electrolyte, the at least one discharge cathode comprising a first side and a second side opposite the first side, wherein the first side is exposed to air or oxygen and the second side is exposed to electrolyte.

### BRIEF DESCRIPTION OF THE FIGURES

The features of certain embodiments will become more apparent in the following detailed description in which reference is made to the appended figures wherein:

FIG. 1 is a schematic configuration of a horizontally configured tri-electrode zinc-air battery with a floating cathode according to an aspect of the description as illustrated in Example A.

### DETAILED DESCRIPTION

In the present description, reference will be made to a zinc-air battery or a zinc-oxygen battery. Such batteries will be known to persons skilled in the art and it will be understood that the terms “zinc-air” and “zinc-oxygen” may be used interchangeably with reference to the same battery.

The terms “comprise”, “comprises”, “comprised” or “comprising” may be used in the present description. As used herein (including the specification and/or the claims), these terms are to be interpreted as specifying the presence of the stated features, integers, steps or components, but not as precluding the presence of one or more other feature, integer, step, component or a group thereof as would be apparent to persons having ordinary skill in the relevant art.

Described herein is a horizontally configured tri-electrode (i.e. three-electrode) single flow zinc-air battery comprising a housing containing at least one discharge cathode, at least one charge cathode, at least one anode, and an electrolyte, wherein the at least one discharge cathode floats on the surface of the electrolyte such that a first side of the discharge cathode is exposed to air (or oxygen) and a second side opposite the first side is exposed to electrolyte.

The battery includes or is associated with an electrolyte flow system comprising an electrolyte storage tank or reservoir, a pumping apparatus, manifold(s), and other piping components to allow flow of the electrolyte between the reservoir and the housing.

The discharge cathode preferably comprises a conductive air permeable and water permeable catalytic oxygen reduction electrode. The discharge cathode is adapted to float on the surface of the electrolyte. This may be achieved in any manner. For example, in one aspect, the discharge cathode may be coated with a hydrophobic film or foam on a first side thereof, wherein the coating is less dense than the electrolyte. In this way, the discharge cathode would float on the electrolyte solution, particularly where the coated first side is oriented to face the electrolyte. The second side of the cathode would then be exposed to the air which is present above the level of the electrolyte.

In another aspect, the discharge cathode may be attached to flexible cables or connectors. In another aspect, the discharge cathode may be connected to a side panel which in turn is slidably coupled to a wall of the housing. In the latter situation, the side panel is adapted to slide vertically with respect to the wall of the housing. It will be understood that various other means may be used to allow the discharge cathode to float on the surface of the electrolyte solution.

The charge cathode preferably comprises an electrolyte permeable metal mesh and/or metal foam electrode. Preferably, the charge cathode is made of a material selected from nickel, nickel alloy, titanium, titanium alloy, stainless steel, and any combination or mixture thereof. Carbon is not used for the charge cathode, thereby avoiding the issue of carbon corrosion discussed above.

The anode comprises an inert conductive electrode where zinc deposition occurs during battery charging and zinc dissolving occurs during battery discharging. The anode may comprise a foil sheet, plate, or foam. The anode material may be selected from carbon/graphite based material, stainless steel, tin, lead, copper, silver, gold, platinum, alloys thereof, and any combination or mixture thereof.

The electrolyte preferably comprises an alkaline solution (0.3-15 M of OH⁻) containing at least one or more soluble zinc salts. Preferably, such salts are selected from ZnO, Zn(OH)₂, K₂Zn(OH)₄, Na₂Zn(OH)₄, or any combination thereof. The concentration of the salt(s) in the electrolyte is preferably 0.1-1.5M.

In one aspect, the battery may be assembled such that: (1) the discharge cathode floats on the surface of the electrolyte such that one side of the discharge cathode is exposed to air, and the other side is exposed to electrolyte; (2) the charge cathode is placed between the discharge cathode and the anode; (3) the electrolyte flow system pumps the electrolyte so as to flow between the cell and an electrolyte supply reservoir or holding tank during battery charging and discharging.

The horizontally configured tri-electrode zinc-air battery with a floating cathode described herein adapts a strategic combination of “horizontal configuration”, “tri-electrode”, “water permeable floating discharge cathode”, “carbonless charge cathode”, “inert anode”, and “electrolyte flow system”. This strategic combination of electrodes and battery components solves four major technical issues: carbon corrosion at the charge cathode; shape change and zinc dendrite formation at the anode; blockage of air tunnels at the discharge cathode; and electrolyte leakage. These components make it practical to build a single cell on a large scale. The battery is further theoretically able to have an unlimited service time, which is very promising for grid energy storage applications.

Carbon corrosion on the cathode mainly happens during battery charging. By using a tri-electrode configuration as described herein, and by using a carbonless metal mesh/foam material as the charging electrode, the conventional carbon based catalytic cathode is protected from carbon corrosion since it is used for discharge purposes only. Thus, the issue of carbon corrosion is obviated.

The combination of an inert anode and an electrolyte flow system in the presently described battery addresses the shape change and zinc dendrite formation issues that may occur at the anode. Since the flowing electrolyte removes zinc ions away from the anode, the battery described herein avoids the partial saturation of zinc ions and the formation of zinc oxides and zinc dendrites during battery discharging.

In conventional rechargeable zinc-air batteries, the reversible reaction on the anode occurs as follows:

Zn+4OH⁻−2e⁻↔Zn(OH)₄²⁻↔ZnO+2H₂O+2OH⁻

Conventionally, Zn(OH)₄²⁻ exists as an intermediary product that is almost immediately deposited on the anode as solid ZnO due to low solubility of Zn(OH)₄²⁻ in the limited amount of electrolyte. While in the presently described battery system, there is a significant amount of flowing electrolyte to dissolve Zn(OH)₄²⁻ and carry it away from the anode, preventing ZnO formation. Therefore the reversible reaction on the anode occurs as follows:

Zn+2e⁻+4OH⁻↔Zn(OH)₄²⁻

In the presently described battery, zinc is deposited onto the surface of the anode during charging and zinc is dissolved back into the electrolyte during discharging. Thus, the surface of the anode is “cleaned” and returned to its “fresh” state after every full discharge, thereby preventing shape change and formation of zinc dendrites on the anode.

The use of a water-permeable and air-permeable discharge cathode in the presently described battery resolves the issue of air tunnel blockage by KOH and K₂CO₃ solids. Balancing hydrophilicity and hydrophobicity at the electrode further prevents blockage of air tunnels by the electrolyte, which can be achieved by adjusting the mass ratio of hydrophilic and hydrophobic additives. Hydrophilic additives, such as activated carbon, are used to store the electrolyte inside the electrode, while hydrophobic additives, such as PTFE provide air tunnels.

A horizontal configuration is used to avoid electrolyte leakage due to water permeability of the discharge cathode. The discharge cathode in the presently described battery floats on the surface of the electrolyte such that a first side is exposed to air and a second side opposite the first side is in good contact with the electrolyte notwithstanding changing electrolyte levels.

Floating of the discharge cathode can be achieved in a number of ways as would be understood by persons skilled in the art. For example, in one aspect, a first surface of the discharge cathode may be provided with a hydrophobic film or foam coating that provides the first surface with a coating of a lower density than the electrolyte. In this way, once the discharge cathode is placed on the surface of the electrolyte, the coating allows the cathode to float on such surface. As will be understood, if the discharge cathode is placed on the electrolyte with the first, coated side, facing the electrolyte, as would be the arrangement in the preferred aspect of the present description, the opposite or second side of the cathode would be exposed to the air or other atmosphere present above the electrolyte solution.

In one aspect, the cathode is attached to the housing by one or more flexible cables so as to secure the cathode from moving out of its position, while still allowing the cathode to float on the electrolyte surface.

In another aspect, the container, or electrolyte bath, may be provided with a sliding side panel, which is slidably connected to one of the side walls of the container containing the electrolyte. The slidable panel may be securely or rigidly connected to the discharge cathode. In this way, if the cathode is moved vertically, the entire panel to which the cathode is attached is also moved. In either of these alternatives, it will be understood that the battery described herein will have a discharge cathode that floats on the surface of the electrolyte thereby allowing the advantages discussed herein to be realized.

The horizontal configuration of the presently described battery allows for a single cell to be constructed on a large scale as it obviates the need to seal the battery using conventional means such as screws. Thus, the issues of air tunnel blockage and electrolyte leakage suffered in the prior art is obviated.

As a preferred solution, the charge cathode further comprises particles of at least one transition metal oxide and/or transition metal hydroxide covered on the surface of the electrode to obtain a lower OER potential and to improve the energy efficiency of the battery. The transition metal is preferably selected from titanium, vanadium, chromium, manganese, iron, cobalt, nickel, or a combination thereof.

The process of preparing the charging electrode having the transition metal oxide and/or transition metal hydroxide particles covered thereon comprises the following steps. First, the transition metal is deposited by chemical plating or electrochemical plating or by using an acid solution to corrode the electrode. Second, the electrode is heat treated in air to oxidize the surface. Alternatively, the battery may be assembled and the oxygen allowed to oxidize the electrode in an alkaline electrolyte during battery charging.

The present inventors have developed a secondary (i.e. rechargeable) zinc-air battery that addresses at least one of the known deficiencies in the prior art. In particular, the battery described herein addresses the known problem of carbon corrosion at the cathode, deterioration of the anode due to zinc dendrite formation, blockage of air tunnels at the discharge cathode, and leakage of electrolyte due to conventional sealing. As a result, the presently described battery is capable of operating effectively for extended periods of time, such as for over 4000 cycles. Thus the battery described herein offers a practical, economical, and commercially viable zinc-air battery.

### EXAMPLES

### Example A

A horizontally configured tri-electrode single flow zinc-air battery with a floating cathode was prepared comprising: a piece of 10 cm×10 cm Ni-foam as the charge cathode; a piece of 9 cm×9 cm catalytic air electrode as the discharge cathode; a piece of 10 cm×10 cm copper foam as the anode; an electrolyte comprising 8 M KOH and 0.8 M K₂Zn(OH)₄; and an electrolyte flow system comprising a pump, a tank, and plastic tubes. The discharge cathode was supported by two flexible cables such that a first side was exposed to air and a second side, opposite the first side, was exposed to electrolyte.

The discharge cathode was prepared by mixing MnO₂ (D₅₀=5-10 um), activated carbon, Super P (carbon black), and PTFE (emulsion) in isopropanol to form a slurry. The mass ratios of each component was 32%:45%:15%:8%. The slurry was coated and pressed onto a piece of nickel foam, then dried in an oven. The electrode was roll pressed to a thickness of 0.5 mm, and heat pressed at 310° C. for 30 min.

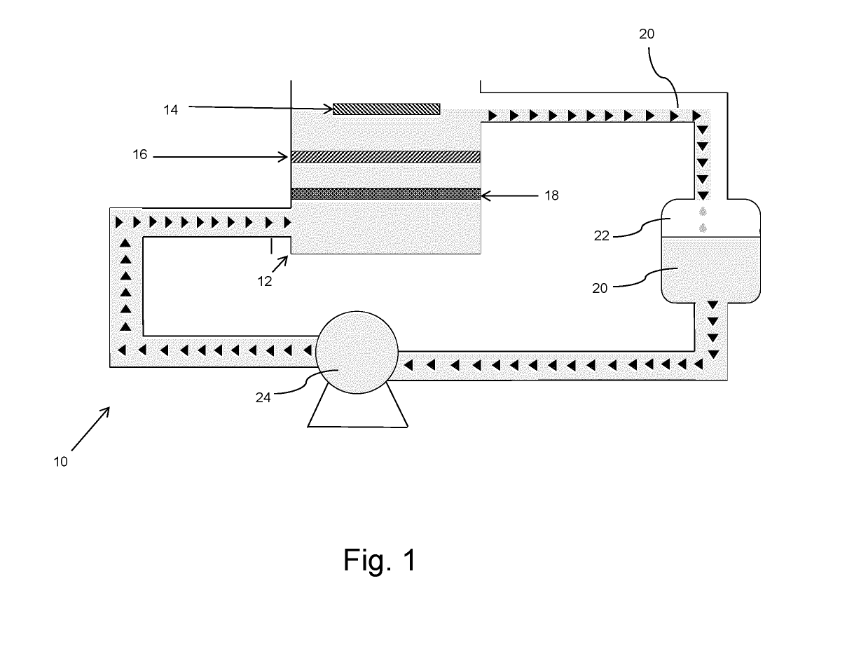

The battery was assembled as shown in FIG. 1. As shown, the battery (10) includes a horizontally configured housing (12) within which is contained a floating discharge cathode (14), a charge cathode (16) and an anode (18). The battery illustrated in FIG. 1 is meant to be illustrative of an aspect of the battery described herein having a single discharge cathode, a single charge cathode, and a single anode. It will be understood that other arrangements of electrodes are possible within the scope of the description as outlined in the appended claims. The housing is adapted to contain a volume of an electrolyte (20) and is associated with, i.e. in fluid communication with, an electrolyte reservoir (22) and a housing (12). A pump (24) is provided along with suitable piping and manifolds, etc.

As can be seen in FIG. 1, one side of the floating discharge cathode is exposed to air, i.e. such side is not exposed to electrolyte, and the other side was exposed to the electrolyte. The charge cathode was placed between the discharge cathode and the anode. The electrolyte flow system was used to pump the electrolyte to cause a flow between the cell or housing and a tank during the battery charging and discharging cycles.

### Example B

A horizontally configured tri-electrode single flow zinc-air battery with a floating cathode was assembled as in Example A. The charge cathode was a piece of 0.2 mm thick stainless steel (316) mesh and the discharge cathode comprised MnO₂ (D₅₀=5-10 um), activated carbon, Super P (carbon black), and PTFE, the mass ratio of each component being 65%:22%:8%:5%. The anode was formed from a piece of stainless steel mesh. The electrolyte comprised 4M NaOH and 0.4 M Na₂Zn(OH)₄.

### Example C

A horizontally configured tri-electrode single flow zinc-air battery with a floating cathode was assembled as in Example A. The charge cathode was a piece of 0.2 mm thick stainless steel (316) mesh and the discharge cathode comprised of CoO₂ (D₅₀≤5 um), activated carbon, Super P (carbon black), and PTFE, the mass ratio of each component was 32%:45%:15%:8%. The anode was a piece of copper mesh. The electrolyte comprised 10 M KOH and 0.2 M K₂Zn(OH)₄.

### Example D

A horizontally configured tri-electrode single flow zinc-air battery with a floating cathode was assembled as in Example A. The charge cathode was a piece of 10 cm×10 cm nickel foam with thickness of 1.5 cm, which was coated by cobalt oxide (CoO) particles.

The CoO-coated piece of nickel foam was prepared by electrochemically depositing a layer of Co(OH)₂ particles onto the nickel foam in an aqueous solution comprising 1 M KCL and 0.5 M CoCl₂. A graphite plate was used as a positive electrode, and the nickel foam was used as a negative electrode. The process was conducted with a charge having a current density of 20 mA/cm² for 15 min to deposit cobalt onto the nickel foam. The foam was then washed and heated at 300° C. for 30 min.

### Example E

A horizontally configured tri-electrode single flow zinc-air battery with a floating cathode was assembled as in Example A. The charge cathode was a piece of stainless steel mesh with a thickness of 0.2 mm. The stainless steel mesh was immersed in 3 M HCL solution for 30 min to result in corrosion on its surface. The mesh was then washed and heated at 300° C. for 30 min.

Although the above description includes reference to certain specific embodiments, various modifications thereof will be apparent to those skilled in the art. Any examples provided herein are included solely for the purpose of illustration and are not intended to be limiting in any way. Any drawings provided herein are solely for the purpose of illustrating various aspects of the description and are not intended to be drawn to scale or to be limiting in any way. The scope of the claims appended hereto should not be limited by the preferred embodiments set forth in the above description, but should be given the broadest interpretation consistent with the present specification as a whole. The disclosures of all prior art recited herein are incorporated herein by reference in their entirety.

We claim:

1. A horizontally configured zinc-air battery, comprising:
a housing containing at least one discharge cathode, at least one charge cathode, and at least one anode, wherein each of the at least one discharge cathode, the at least one charge cathode, and the at least one anode is substantially horizontally configured;
an electrolyte adapted to flow through the housing, the electrolyte comprising a solution containing at least one zinc salt dissolved therein;
the at least one charge cathode comprising a non-carbon metal mesh and/or metal foam material;
the at least one anode and the at least one charge cathode being provided within the housing and submerged in the electrolyte; and
the at least one discharge cathode being provided in the housing and is adapted to float on the surface of the electrolyte, the at least one discharge cathode comprising a first side and a second side opposite the first side, wherein the second side is exposed to air or oxygen and the first side is exposed to the electrolyte.

2. The battery of claim 1, wherein the at least one discharge cathode is provided with a coating on the first side, the coating being of a lower density than the electrolyte, thereby allowing the at least one discharge cathode to float on the surface of the electrolyte.

3. The battery of claim 2, wherein the coating comprises a hydrophobic film or a hydrophobic foam.

4. The battery of any one of claims 1 to 3, wherein the discharge cathode is attached to at least one flexible cable.

5. The battery of claim 1, wherein the at least one discharge cathode is attached to a slidable panel coupled to a wall of the housing such that the panel is able to slide vertically along at least a portion of the wall of the housing.

6. The battery of claim 5, wherein the at least one discharge cathode is provided with a coating on the first side, the coating being of a lower density than the electrolyte, thereby allowing the at least one discharge cathode to float on the surface of the electrolyte.

7. The battery of claim 6, wherein the coating comprises a hydrophobic film or a hydrophobic foam.

8. The battery of any one of claims 1 to 7, wherein the at least one discharge cathode comprises a conductive air permeable, water permeable catalytic oxygen reduction electrode.

9. The battery of any one of claims 1 to 8, wherein the at least one discharge cathode is formed of a combination of PTFE and activated carbon.

10. The battery of any one of claims 1 to 9, wherein the electrolyte is contained in an electrolyte reservoir and is pumped through the housing.

11. The battery of any one of claims 1 to 10, wherein the electrolyte is alkaline.

12. The battery of any one of claims 1 to 11, wherein the housing comprises one or more manifolds and/or piping for permitting flow of the electrolyte.

13. The battery of any one of claims 1 to 12, wherein the electrolyte comprises one of NaOH, KOH, LiOH or any mixture thereof.

14. The battery of any one of claims 1 to 13, wherein the electrolyte solution is alkaline and the alkaline concentration is 0.3 to 15 M.

15. The battery of any one of claims 1 to 14, wherein the at least one zinc salt is at least one of ZnO, Zn(OH)₂, K₂Zn(OH)₄, Na₂Zn(OH)₄, or any combination thereof.

16. The battery claim 15, wherein the concentration of the at least one zinc salt is 0.1 to 1.5 M.

17. The battery of any one of claims 1 to 16, wherein the at least one anode comprises a conductive, inert electrode adapted to allow zinc deposition during the charging phase and zinc dissolution into the electrolyte during the discharge phase.

18. The battery of any one of claims 1 to 17, wherein the at least one anode is in the form of a foil, sheet, plate, or foam.

19. The battery of any one of claims 1 to 18, wherein the at least one anode is formed of a carbon/graphite based material, stainless steel, tin, lead, copper, silver, gold, platinum, alloys thereof, or any combination or mixture thereof.

20. The battery of any one of claims 1 to 19, wherein the at least one charge cathode is formed of stainless steel, nickel, titanium, alloys thereof, or any combination or mixture thereof.

21. The battery of claim 20, wherein the at least one charge cathode further comprises particles of a transition metal oxide and/or a transition metal hydroxide, wherein the transition metal is selected from the group of titanium, vanadium, chromium, manganese, iron, cobalt, nickel, or any combination or mixture thereof.
